(19) United States
(12) Patent Application Publication
(10) Pub. No.: US 2005/0027960 A1
(43) Pub. Date: Feb. 3, 2005

(54) Translation look-aside buffer sharing among logical partitions

(75) Inventors: Jonathan James DeMent, Austin, TX (US); Cathy May, Millwood, NY (US); Naresh Nayar, Rochester, MN (US); Edward John Silha, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/631,535

(22) Filed: Jul. 31, 2003

(51) Int. Cl. G06F 12/08

(52) U.S. Cl. 711/207; 711/209

(57) ABSTRACT

The present invention provides for storing and using a stored logical partition indicia in a TLB. A partition in a microprocessor architecture is employed. A virtual page number is selected. A stored LPID indicia corresponding to the selected page number is read from a TLB. The stored logical partition indicia from the TLB is compared to a logical partition indicia associated with the employed partition. If the stored logical partition indicia and the logical partition indicia associated with the employed partition match, a corresponding page table entry stored in the translation look-aside buffer is read. If they do not match, a page table entry from a page table entry source is retrieved and stored in the TLB. If a partition is to invalidate an entry in the TLB, a TLB entry command is generated and used to invalidate a memory entry.

### TECHNICAL FIELD

The invention relates generally to use of a translation look-aside buffer and, more particularly, to use of a translation look-aside buffer with multiple software partitions.

### BACKGROUND

Generally, a translation look-aside buffer (TLB) is a cache that keeps track of recently used memory mapping translation table entries (or page table entries). When a memory access is requested by the system, the TLB is consulted to determine the location of the desired memory. If the translation table entry for the address of the requested memory location is stored inside the TLB, the memory address is retrieved from the TLB. However, if the translation table entry for the memory address is not in the TLB, the table entry is retrieved from the system page table, and stored in the TLB. The memory address is therefore available for the current request and future requests if the address memory location is re-selected.

A plurality of software partitions can be run on the same chip. A software partition can be an operating system, or some other form of independent modules of software for which unique address mappings are defined. When a plurality of software partitions are run, the corresponding TLB entries for each partition are stored and reloaded as each partition is switched on and off the chip. This typically is a time-intensive procedure. In order to reload the TLB, many separate memory accesses occur. Furthermore, each of these memory accesses has the potential to miss in memory and cause an “interrupt.” This can lead to performance problems. Certain real time systems cannot tolerate this unpredictable time of latency and need a way to guarantee the overhead time of a partition context switch.

Therefore, what is needed is a system to run multiple partitions simultaneously, without conflict, in a TLB that overcomes at least some of the disadvantages of conventional TLB partitions.

### SUMMARY OF THE INVENTION

The present invention provides for using stored logical partition identifier (LPID) indicia in a TLB. A partition in a microprocessor architecture is employed. A virtual page number (VPN) is selected, the memory address to be translated. A stored LPID indicia corresponding to the selected VPN is read. The stored LPID indicia is compared to an LPID register associated with the employed partition. If the stored LPID indicia and the LPID register associated with the employed partition match, a corresponding page table entry (PTE) stored in the TLB is read. If the stored LPID and the LPID associated with the employed partition do not match, a miss occurs and the missing PTE is retrieved from a page table entry source. In one aspect, a TLB entry can be invalidated upon generation of a TLB invalidate command.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a TLB with a stored LPID indicia for determining which page table entry is to be read;

FIG. 2 schematically depicts a TLB with a stored LPID indicia with an invalidate enable indicia for storage within the TLB; and

FIG. 3 schematically depicts a TLB table with its associated inputs for writing a page table entry as a result of a miss.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

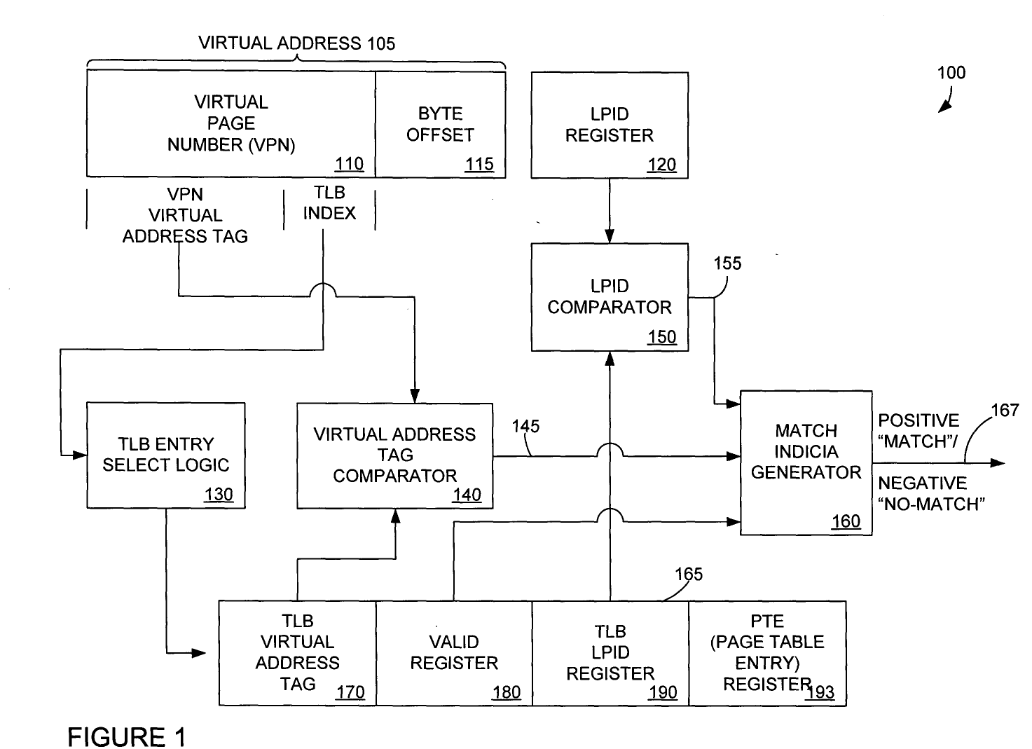

Turning to FIG. 1, disclosed is a TLB partition system 100. In a TLB cache 165, a TLB LPID register 190 is employed. Generally, when a TLB translation “misses” within the TLB 165, the resulting newly created TLB entry is tagged with the LPID value of the currently running partition, as determined from LPID register 120. For a translation to “hit” in the TLB 165, the current value of the LPID for the running partition as determined from the LPID register 120 matches the value stored in the TLB LPID register 190 of the TLB cache 165. Generally, the LPID uniquely identifies the partition (or unique virtual-to-real address mapping) for a given address translation.

The LPID identifier corresponds to a particular partition that is running on an MPU or other processing device. When the TLB 165 stores the physical address for an address mapping, it also stores an LPID for that physical address. In other words, the TLB 165 records, for each record in the virtual address tag 170, the partition with which it is associated. The LPID register 120 is derived from the present or selected partition running on the MPU.

In the system 100, the LPID is employed to differentiate two otherwise-identical virtual-to-real address mappings within the TLB 165. Through employment of the LPID, two separate partitions that maintain separate virtual-to-real address mappings, which otherwise would have identical indicia stored within the TLB 165, are distinguished. In the system 100, indicia means either a single indicator, or a plurality of indicators, as appropriate.

The system 100 has a virtual address 105, which has a virtual page number (VPN) 110 and a byte offset 115. The virtual address 105 is the address that is requested by an MPU or other device (not illustrated). The VPN 110 is further broken down into a TLB index and a VPN virtual address tag (VAT). The TLB index represents the last portion of the VPN 110, and the VPN VAT represents the first portion of the VPN 110. In one embodiment, the TLB index employs the last 8 bits of the virtual page number.

The TLB index is conveyed to a TLB entry select logic (selector) 130. The selector 130 uses the TLB index to determine which row of the TLB 165 is selected to determine the desired memory address. A row of the TLB 165 could contain the memory location of a requested virtual address in one of its plurality of entries corresponding to the specified row.

In the system 100, the selected row, comprising a plurality of columns corresponding to the same TLB index, is conveyed to a virtual address tag comparator (tag comparator) 140. Each of the entries of the selected row, corresponding to a TLB virtual address tag 170, is compared to the VPN VAT within a virtual address tag comparator 140. For each entry, a logical output 145 is generated. If the VPN virtual address tag corresponds to the TLB virtual address tag value stored for a selected row, the logical output of the TLB comparator output 145 is positive for that entry. Otherwise, the TLB comparator output 145 is negative.

In one embodiment, each entry in the TLB virtual address tag 170 has its corresponding valid register 180. The valid register 180 indicates whether a particular entry of the TLB virtual address tag 170 has good data stored within, or whether the data stored within is not good data, such as can be created during a power-up.

The value from the LPID register 120 is compared to the TLB LPID register 190 in the LPID comparator 150. If there is a match (that is, both the LPID register 120 and the TLB LPID register 190 belong to the same partition), the LPID comparator output 155 is positive. Otherwise, the LPID comparator output 155 is negative.

Outputs 145, 155, and the valid register indicia 180 are input into a match indicia generator 160. If all three inputs are positive, the output 167 is positive, and there is a match between the currently employed partition as determined from the LPID register 120 and information about that partition stored in memory corresponding to the TLB LPID register 190. The TLB 165 therefore employs a corresponding PTE register 193 to the approved entry in TLB virtual address tag 170, and a positive match signal 167 is generated. The datum, or data, is then returned to the MPU.

If any of the three inputs into the match indicia generator 160 are negative, the output 167 is negative. The negative match signal 167 causes the TLB 165 to fetch the virtual-to-real mapping from a page table (not shown) in the main memory system, and then store the resulting data in the PTE register 193. The data is then returned to the MPU.

In other words, in the system 100, when an MPU or other processing device is to fetch an instruction or data from the memory system, the MPU first finds where the instruction or data is located. To do this, the MPU presents a virtual address 105 to the TLB 160. The TLB then uses a portion of the address (the TLB index) to index into the TLB 165, and the remaining portion (the VPN VAT) to compare against the cache entries in the TLB 165.

If the virtual address is found within the cache 165, the resulting real address and attributes that form the PTE register are then sent back as a result to the MPU. If the same virtual address, however, can map to two unique real addresses, an ambiguity has arisen. Since each partition or page table maintains its own virtual-to-real address mapping, this situation can arise if the TLB 160 keeps both of the mappings at the same time. In order to distinguish them, the TLB LPID register 190 is used.

The LPID register reflects the currently active partition or page table on the MPU. If the MPU changes partitions, it also changes the value within the LPID register 120. The TLB 165 utilizes this information to further “tag” its entries in the TLB LPID register 190. LPID tagging ensures that any ambiguity as to which partition a particular VAT corresponds is resolved. In the system 100, through employment of the LPID register 120 and the TLB LPID register 190, it is not necessary to save and restore TLB 165 entries during a partition or page table switch on the processor. This is because the TLB 165 of the system 100 can maintain both virtual-to-real address mappings for both partitions without ambiguity or conflict, as each partition is uniquely identified in the TLB LPID 190.

When a TLB entry is created for a particular TLB virtual address tag 170, the TLB LPID register 190 value used to “tag” the entry is the LPID of the currently active partition on the processor, as evidenced by the LPID register 120. This insures that this entry will not be used if the active partition is a different partition from the partition that stored the original LPID register 120 value.

In a further embodiment, the LPID value can comprise a value that matches all partitions. In other words, all partition values stored in the TLB LPID register 190 would be matched with their corresponding entries in the TLB virtual address tag 170. This is equivalent to a particular TLB LPID register value that causes the LPID comparator output 155 to always be positive. This could be useful, for instance, for memory regions that are shared across all partitions, such as hypervisor memory.

In a further embodiment, an LPID can represent any unique page table (or virtual-to-real address mapping) in addition to partitions. In this, a hypervisor, which can be generally defined as a master operating system in charge of balancing system resource usage for other operating systems, can assign a unique LPID for each page table that is in use at any given time. This is substantially equivalent to defining the LPID as a “logical page-table identifier.” The operating system can be Linux.

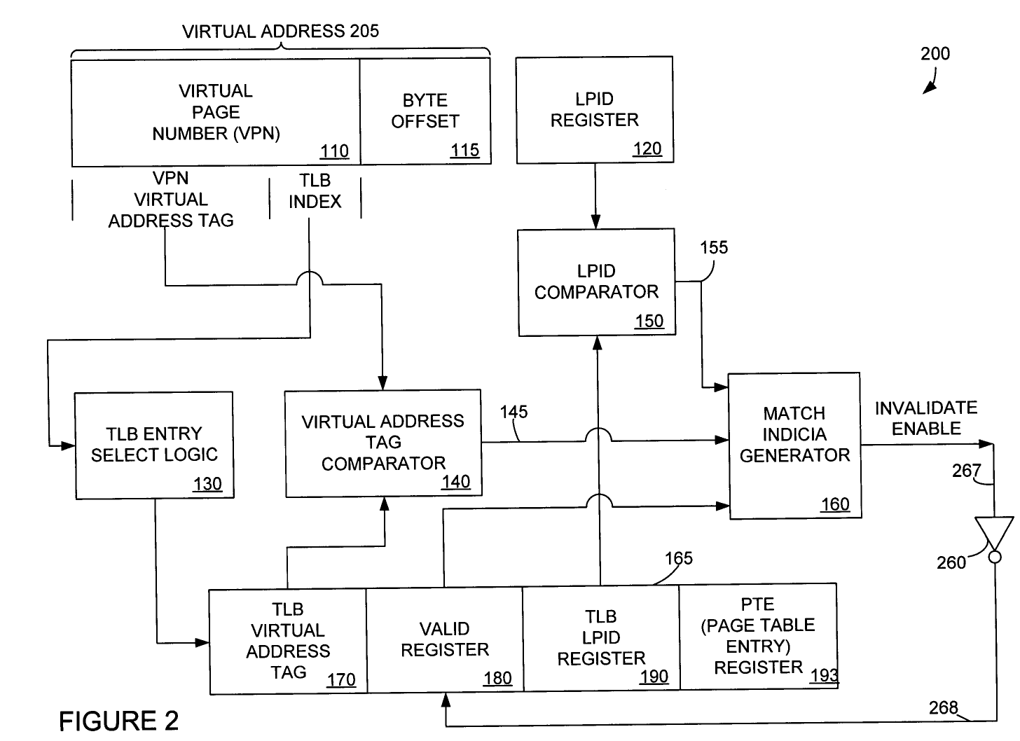

Turning now to FIG. 2, disclosed is a system 200 to invalidate a TLB virtual tag address 170 within the TLB 165. In FIG. 2, an invalidation can occur when a portion of memory no longer exists or is removed. For example, a process can lose its address, such as when the operating system over-rides the ownership of the memory and reallocates it for another process. In other words, these memory entries can become no longer valid, and the system 200 explicitly invalidates this memory entry.

In a multi-processor system, one processor may send out an invalidate command to all other processors in the system, insuring that all TLBs in the system are notified and all references to a particular translation entry are removed system-wide. Alternatively, the processor may wish to send the invalidate command to a local TLB only and not to any other processors or TLBs in the system. This is useful for systems that employ a page table per processor or in the event of parity errors that are localized to an individual processor or TLB. In the following discussion, it is assumed that the source of the invalidate command can be a processor directly connected to the TLB or a remote processor issuing an invalidate command over an inter-processor communication bus.

In the system 200, the VPN VAT is employed by the TLB 165 and the TLB comparator 140 in a manner similar to system 100. The valid register 180 is also employed in a manner similar to system 100.

System 200 is employed during the TLB invalidate command. From the LPID register 120, the indicia of the LPID partition that has issued the TLB invalidate command is conveyed to the comparator 150. The indicia from the TLB LPID register 190 for each of the entries corresponding to the TLB virtual address tag 170 are also conveyed to the LPID comparator 150, which generates a positive or negative signal 155, as appropriate. The signal 155 is conveyed to the match indicia generator 160.

The match indicia generator 160 generates an output 267 of “invalidate” if all three inputs to generator 160 are positive. Otherwise, the output 267 of the generator 160 is set to “valid.” The output 267 is inverted by an inverter 260 and output as output 268. The output 268 is stored in the valid register 180. Hence an entry matching the VAT and LPID 120 which is valid will now be marked invalid as a result of the command.

Generally, when a processor seeks to invalidate TLB entries in the TLB 165, it should only do so for the currently active partition. Thus, the LPID is sent with the TLB invalidate entry (TLBIE) command along with the virtual address to delete from the TLB 165. An entry must match this virtual address and LPID to be invalidated. Setting the valid bit of the valid register 180 of the matching TLB virtual address tag 170 entry to zero completes the invalidation command. In a further embodiment, a special form of the TLBIE command can be sent out that matches all LPID values. This allows the MPU to remove all entries from a TLB 165 if necessary (for example, in the event of a recoverable TLB parity error). In another embodiment, a partition can act on another partition's behalf by temporarily setting the LPID register value to the other partition's value and then issuing TLB invalidate commands.

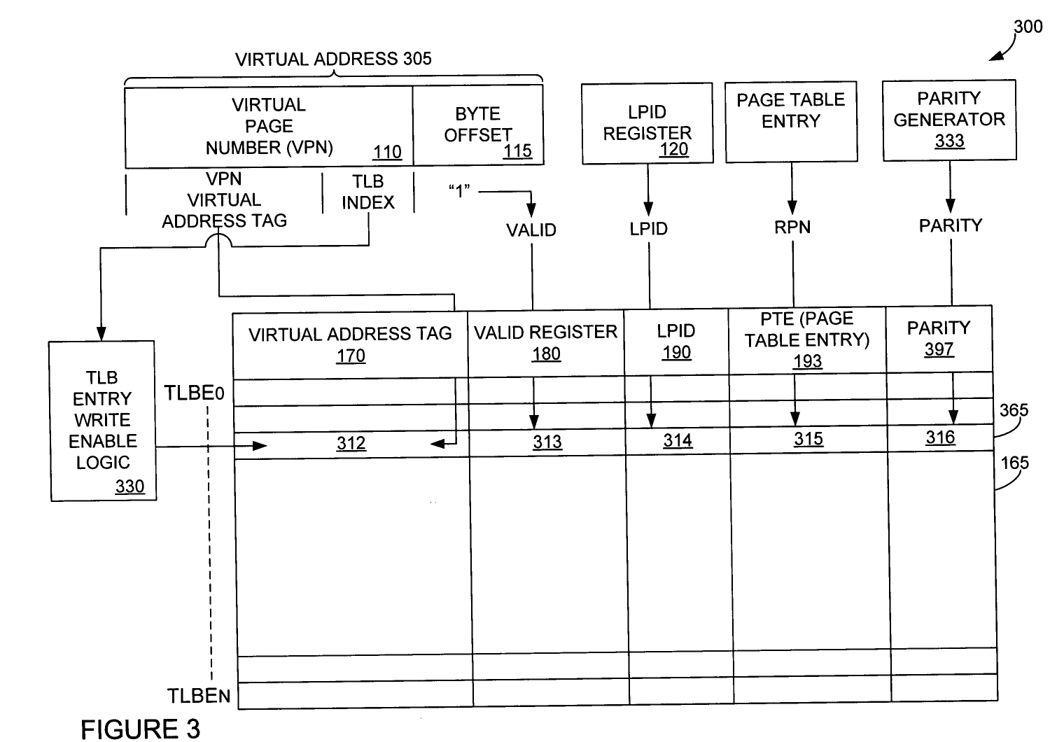

Turning now to FIG. 3, disclosed is a system 300 for loading and updating a TLB 165. In the system 300, the VPN 110 is parsed into a TLB index and a virtual address tag. If the MPU so indicates or a PTE reload occurs, a TLB entry write enable 330 writes the VAT into an entry 312 at column 170 in row 365 of the TLB 165. Also, a “1” value is input into entry 313 of column 180. The current LPID value is stored in entry 314 of column 190. The corresponding PTE real address and attribute values are stored in entry 315 of column 193. Finally, a parity value is created by a parity generator 333 and is input into entry 316 of column 397.

In FIG. 3, a write to the TLB 165 can be done for a plurality of reasons. For instance, if a miss occurs when trying to read PTE information from the TLB 165, the correct PTE is loaded from the page table and written to the TLB 165. For a second reason, software can write to a TLB entry 365 before accessing the TLB 165 to avoid a miss. In other words, the software predicts that an access will occur to a certain page, and indicia from the PTE representing this page is stored in the TLB 165. This can improve performance.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for use of a translation look-aside buffer (TLB) in microprocessor architecture for employment with partition switching, comprising:
establishing a plurality of partitions associated with the microprocessor architecture; and
inputting indicia of the plurality of the multiple partitions into the TLB.

2. A method of using stored logical partition indicia (LPID) of a TLB, comprising:
employing a partition in a microprocessor architecture;
selecting a virtual page number (VPN);
reading a stored LPID indicia corresponding to the selected VPN;
comparing the stored LPID to an LPID associated with the employed partition;
if the stored LPID and the LPID associated with the employed partition match, reading a corresponding page table entry stored in the TLB; and
if the stored LPID and the LPID associated with the employed partition do not match, retrieving a page table entry from a page table entry source.

3. The method of claim 2, further comprising storing an invalidating indicia corresponding to the LPID indicia

4. The method of claim 2, further comprising storing LPID indicia in the TLB.

5. The method of claim 4, further comprising storing a validating indicia corresponding to the stored LPID indicia.

6. The method of claim 2, wherein retrieving the page table entry value further comprises retrieving from a main memory.

7. The method of claim 2, further comprising selecting and invalidating an entry within the TLB if the stored LPID and the LPID associated with the employed partition match.

8. The method of claim 2, further comprising loading the corresponding page table entry in the TLB from the page table entry source if the stored LPID and the LPID associated with the employed partition do not match.

9. The method of claim 2, further comprising employing software to load a page table entry in the TLB from the page table entry source in order to prevent a future miss that would otherwise result from a stored mismatching LPID.

10. The method of claim 2, further comprising inputting a valid indicia, a virtual address tag comparison indicia and an LPID comparison indicia to determine the status of the match.

11. The method of claim 2, further comprising changing from one partition to a second partition.

12. The method of claim 2, further comprising storing a new LPID indicia in the LPID register corresponding to the second partition.

13. A method for invalidating an entry in a TLB, comprising:
receiving a TLB invalidate command for a TLB entry;
comparing the LPID indicia of the TLB invalidate command to the LPID indicia of candidate TLB entries;
generating an LPID comparison output;
receiving a virtual address tag;
if both the LPID comparison output and the virtual address tag match for a candidate TLB entry, generating an invalidate indicia for the TLB entry; and
storing the invalidate indicia in a register of the TLB entry to be invalidated.

14. The method of claim 13, further comprising sending an invalidate command tagged with an LPID indicia to a plurality of TLBs, wherein each TLB corresponds to a separate processor.

15. The method of claim 13, further comprising sending an invalidate command tagged with an LPID indicia to the TLB corresponding to a first processor, but not sending the invalidate command to a TLB corresponding to a second processor.

16. The method of claim 13, further comprising sending an invalidate command tagged with a particular LPID indicia that forces all candidate TLB entry LPID comparison outputs to match to indicate a match.

17. A system of sharing a TLB with multiple partitions, comprising:
a TLB logical partition indicia register;
a virtual address tag comparator coupled to the TLB; and
an LPID comparator coupled to the TLB LPID register.

18. The system of claim 17, wherein the multiple partitions comprise separate operating systems.

19. The system of claim 18, wherein at least one operating system is Linux.

20. The system of claim 17, further comprising a match generator coupled to the LPID comparator.

21. The system of claim 17, further comprising a match generator coupled to the output of the LPID comparator and the virtual address tag comparator.

22. The system of claim 17, further comprising a TLB entry select logic coupled to the TLB.

23. The system of claim 17, further comprising a TLB entry write enable logic coupled to the TLB.

24. The system of claim 17, further comprising a valid register coupled to the match generator.

25. A computer program product for using stored LPID indicia of a TLB in a computer system, the computer program comprising:
computer code for selecting a virtual page number (VPN);
computer code for accessing corresponding stored LPID indicia of the VPN;
computer code for employing the corresponding page table entry stored in the TLB if the stored LPID and the LPID associated with the employed partition match; and
computer code for retrieving a page table entry from a page table entry source if the stored LPID and the LPID associated with the employed partition do not match.

26. A processor for using stored LPID indicia of a TLB in a computer system, the processor including a computer program comprising:
computer code for selecting a virtual page number (VPN);
computer code for accessing corresponding stored LPID indicia of the VPN;
computer code for employing the corresponding page table entry stored in the TLB if the stored LPID and the LPID associated with the employed partition match; and
computer code for retrieving a page table entry from a page table entry source if the stored LPID and the LPID associated with the employed partition do not match.
